(19) United States
(12) Patent Application Publication
(10) Pub. No.: US 2021/0388665 A1
(43) Pub. Date: Dec. 16, 2021

(54) FRAME FOR A FAÇADE, A FAÇADE ELEMENT, A WINDOW OR DOOR

(71) Applicant: SCHÜCO INTERNATIONAL KG, Bielefeld (DE)

(72) Inventors: Frank ZIMMERMANN, Herford (DE); Jürgen MEYER, Bad Oeynhausen (DE); Hans-Walter BIELEFELD, Bielefeld (DE); Rolf NIENHÜSER-SONNENSCHEIN, Melle (DE); Carsten HANKE, Bielefeld (DE)

(21) Appl. No.: 17/279,165

(22) PCT Filed: Sep. 23, 2019
(86) PCT No.: PCT/EP2019/075514

§ 371 Date: Mar. 24, 2021

(30) Foreign Application Priority Data
Sep. 25, 2018 (DE) 10 2018 123 629.8
Mar. 28, 2019 (DE) 10 2019 107 994.2
Mar. 28, 2019 (DE) 10 2019 107 996.9

(51) Int. Cl. E06B 3/54; E06B 3/26; E06B 3/66; E06B 7/12; E04B 2/96

(52) U.S. Cl. CPC E06B 3/549; E06B 3/26; E04B 2/967; E06B 7/12; E06B 3/6621

(57) ABSTRACT

A frame for a façade, a façade element, a window or a door is formed from a number of profiled elements, at which an insulating glazing unit having at least two glass panes held at a distance from one another is retained. An intermediate space under negative pressure is formed between the glass panes. The insulating glazing unit is clampingly retained at the edge thereof between an inner sealing profiled element and an outer sealing profiled element and pressure strips are provided on the exterior of the insulating glazing unit, which pressure strips are fastened to the profiled elements of the frame. A thermal-conductor arrangement is provided on and/or in the inner sealing profiled elements at least in some areas. Due to the thermal-conductor arrangement, heat can be fed to the edge of the insulating glazing unit lying against the inner sealing profiled element in the event of cold outside temperatures.

### BACKGROUND AND SUMMARY OF THE INVENTION

Exemplary embodiments of the present invention relate to a frame for a façade, façade element, window or door, which frame is formed from a plurality of profiled elements and on which an insulating glazing unit having at least two glass panes held at a distance from one another is retained, between which glass panes an intermediate space subjected to negative pressure is formed, wherein the insulating glazing unit is retained in a clamping manner at the edge thereof between an inner sealing profiled element and an outer sealing profiled element, and pressure strips are provided on the exterior of the insulating glazing unit, which pressure strips are fastened to the profiled elements of the frame.

DE 10 2012 112 279 A1 discloses a window on a façade in which a thick insulating glazing unit is held clamped between an inner sealing profiled element and an outer sealing profiled element. The outer sealing profiled element is connected to a profiled element of a frame via a pressure strip, with an insulating web being provided in a region adjacent to an end face of the insulating glazing unit, which prevents too much heat from flowing from the inside to the outside via the end face edge region when outside temperatures are cold. In the case of insulating glazing units, this can prevent an inner side of the insulating glazing unit from becoming too cold in the edge region, which could lead to the formation of condensation in the cold region.

EP 2 327 855 B1 discloses an insulating glass unit having a vacuum insulating glass element arranged in a special edging profiled element. The vacuum insulating glass element and the edging profiled element form a unit that is mounted on supporting elements. Such vacuum insulating glass elements have particularly good thermal insulation properties, but there is the problem that the edging of the edge region by the edging profiled element is comparatively costly and visually disadvantageous. Without the edging profiled element, condensation can form in the edge region adjacent to an inner seal of a supporting structure at cold outside temperatures.

FIG. 15 shows a sectional view through a frame for a prior art window 83 comprising a fixed frame 84 and a sash frame 85, each formed of profiled elements. An insulating glazing unit 80 is clamped to the sash frame 85 between a first sealing profiled element 82 and a second sealing profiled element 81. The insulating glazing unit 80 has a thickness of at least 28 mm, so that insulating webs and other insulating elements for a high level of thermal insulation can be provided on the profiled elements of the fixed frame 84 and the sash frame 85 in the region of the end face of the insulating glazing unit 80. The installation of a thinner insulating glazing unit changes the heat flow and requires measures to adjust the sash frame.

Accordingly, exemplary embodiments of the present invention are directed to a window or door that has high thermal insulation and avoids the formation of condensation in the edge region.

In the window or door according to the invention, an insulating glazing unit is used in which an intermediate space between the glass panes is subjected to negative pressure, so that the thermal conductivity and also the thickness of the insulating glazing unit are low. In order to avoid cold spots in the edge region, according to the invention, a thermal-conduction means is provided on and/or in the inner sealing profiled element, at least in certain regions, by means of which heat can be supplied to the edge of the insulating glazing unit abutting the inner sealing profiled element at cold outside temperatures. Although the thermal-conduction means increases the thermal conductivity in a certain region, which somewhat worsens the thermal insulation, the edge region of the insulating glazing unit is thereby kept at a somewhat higher temperature, which avoids the formation of condensation in the edge region adjacent to the inner sealing profiled element. Alternatively, or additionally, heat conduction can be increased by a low thickness of the inner sealing profiled elements, wherein the inner sealing profiled elements are thinner than 4 mm, preferably thinner than 3 mm, in a direction perpendicular to the plane of the insulating glass pane. In this case, the thickness of the seal is measured by measuring the distance between the surface of insulating glazing unit and the end face facing the insulating glazing unit of a groove wall of the profiled element for accommodating a foot a seal. As a result, the entire construction of the window or door can have very good thermal insulation, without fear of the formation of condensation in the edge region at normal room temperatures. The risk of condensation can be kept low despite the small thickness of the vacuum insulating glazing unit by increasing the heat supply from the inside, i.e., thermal coupling.

Preferably, at an outside temperature of −10° C. and an inside temperature of 20° C., the thermal-conduction means allow the 10° C. isotherm to run along the window or door in such a way that it does not touch the inside of the insulating glazing unit. This ensures that at corresponding temperatures the inside of the insulating glazing unit has a temperature above 10° C., which in most cases avoids the formation of condensation.

The thickness of the insulating glazing unit is preferably less than 13 mm, in particular the thickness can be less than 10 mm. The insulating glazing unit subjected to negative pressure can have a thickness of between 5 mm and 9 mm, for example.

The negative pressure in the space between the two glass panes is preferably less than 0.3 mbar, for example less than 0.2 mbar, preferably less than 0.001 mbar, so that particularly good thermal insulation is provided in the region of the insulating glazing unit.

The thermal-conduction means can in itself have a thermal conductivity of more than 10 W/mK. By choosing a small cross-section of the thermal-conduction means, the heat loss can thus be kept low.

The thermal-conduction means may comprise a metallic material. For example, the thermal-conduction means may be formed by at least one metal insert inserted into or disposed on the inner sealing profiled element. The metal insert may optionally be in powder form and distributed in the inner sealing profiled element, such that the thermal conductivity is increased compared to a sealing profiled element made of EPDM. Alternatively, or additionally, a metal foil can be used as a thermal-conduction means, for example an aluminum foil. The metal foil can be in contact with a surface of the sealing profiled element and/or the insulating glazing unit to provide a heat flow from the inner side to the edge region of the insulating glazing unit.

Alternatively, or additionally, a thermally conductive sealant can be arranged between the profiled element and the insulating glazing unit next to the inner sealing profiled element, which slightly heats the edge region of the insulating glazing unit.

Preferably, the glass insertion of the insulating glazing unit is between 5 to 25 mm, in particular between 10 to 15 mm.

In a preferred design of the invention, the frame is designed as a sash frame of a window or a door, which is preferably held pivotably in a fixed frame formed from profiled elements. On one of the two outer sides of the insulating glazing unit, pressure strips in the form of glazing beads are then provided, which are fixed to the profiled elements of the sash frame. The glazing beads can be clamped and/or latched to the sash frame in an exchangeable manner. For good heat conduction, the glass retaining strips can be made of metal, even if the sash frame is made of profiles with a low thermal conductivity, such as plastic. Preferably, the profiled elements of the sash frame are designed as composite profiled elements comprising a metallic outer profiled element and a metallic inner profiled element, which are connected to each other via at least one thermally insulating middle profiled element.

### BRIEF DESCRIPTION OF THE DRAWING FIGURES

The invention is explained in more detail below by means of several exemplary embodiments with reference to the accompanying drawings, wherein:

FIG. 1 shows a sectional view through a frame according to a first exemplary embodiment of the invention;

FIGS. 2 to 8 show cross-sectional views through variants for manufacturing a window or door according to the invention;

FIG. 9 shows a sectional view through a modified frame of a façade construction

FIG. 10 shows a view of a frame for a window, once in the prior art and twice in an embodiment according to the invention;

FIG. 11 shows a view of a frame for a window according to a modified exemplary embodiment

FIG. 12 shows a second exemplary embodiment of a frame according to the invention;

FIG. 13 shows a modified embodiment of a frame, and

FIG. 14 shows a further sectional view through a plastic frame according to the invention, and

FIG. 15 shows a view of the frame for a prior art window.

### DETAILED DESCRIPTION

A façade, skylight, window, door or mullion and transom construction comprises a frame composed of individual profiled elements 1 forming part of a supporting structure. In the following figures, only a sectional view through one of the profiled elements 1 of the frame is shown in each case, which holds two adjacent insulating glazing units 4, although alternatively an insulating glazing unit can also be arranged on only one side.

The profiled element 1 has two grooves 2 on an outer side, to each of which an inner sealing profiled element 3 is fixed. A drainage channel 16 is provided adjacent to the groove 2, and a screw groove or fastening projection 15 is provided in a central region between the grooves 2. The geometry of the profiled element 1 can be adapted to the particular application, for example only one groove 2 can be provided.

In order to fix an insulating glazing unit 4 to the edge of the profiled element 1, a pressure profiled element 8 is provided which can be fixed to the fastening projection 15 by fastening means, for example screws. The pressure profiled element 8 has two grooves, at each of which an outer sealing profiled element 7 is inserted in each case. As a result, each insulating glazing unit 4 is fixed at the edge between an inner sealing profiled element 3 and an outer sealing profiled element 7. The sealing profiles 3 and 7 can be made of EPDM or TPM or a mixture of different elastic materials, preferably by coextrusion.

The insulating glazing unit 4 comprises at least two glass panes 5, which are spaced apart from one another and form an intermediate space 6 between them. The glass panes 5 are sealed at the edges by sealants, and the intermediate space 6 is subjected to a negative pressure, in particular a negative pressure of less than 0.3 bar. Several spacers can be distributed between the glass sheets 5.

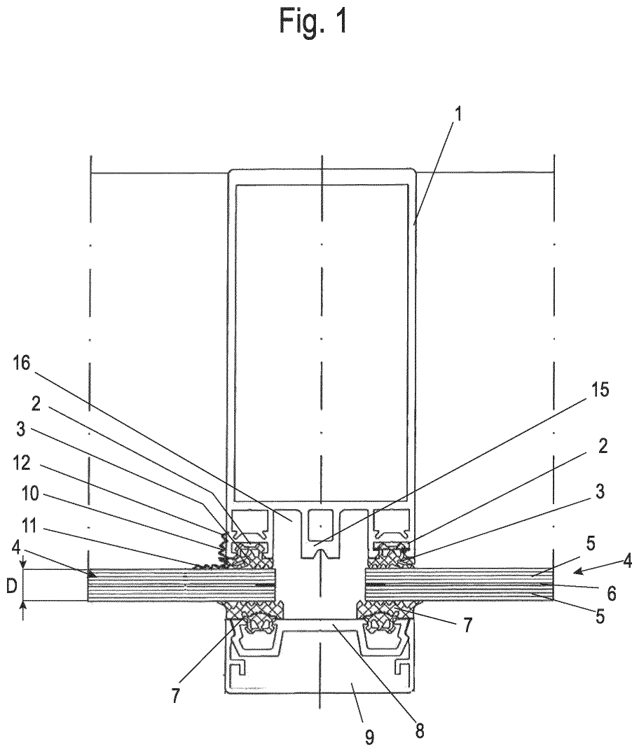

The insulating glazing unit 4 has a thickness D that is less than 13 mm, for example in a range between 6 mm and 10 mm. On the right side of FIG. 1, the conventional mounting method for the insulating glazing unit 4 is shown. Due to the low thickness D of the insulating glazing unit 4, the edge region of the insulating glazing unit 4 may cool down at cold outside temperatures, causing the inner region of the insulating glazing unit 4 adjacent to the inner sealing profiled element 3 to fall below a certain temperature, for example less than 10° C., at the surface. As a result, condensation can easily form on the inside due to the cooling of the edge region.

In order to prevent the formation of such condensation in the region adjacent to the inner sealing profiled element, a thermal-conduction means 10 in the form of a metal foil, in particular an aluminum foil, is schematically drawn on the left-hand side. A first leg 11 of the metal foil is bonded to the inner side of the insulating glazing unit 4, and a second leg 12 of the metal foil is in contact with the profiled element 1. The profiled element 1 may be made of metal, for example aluminum, and by heating the interior, heat can now be conducted via the metal foil from the leg 12 to the leg 11 during cold outside temperatures, which slightly heats the edge region of the insulating glazing unit 4 adjacent to the inner sealing profiled element 3. This can prevent the formation of condensation in the edge region.

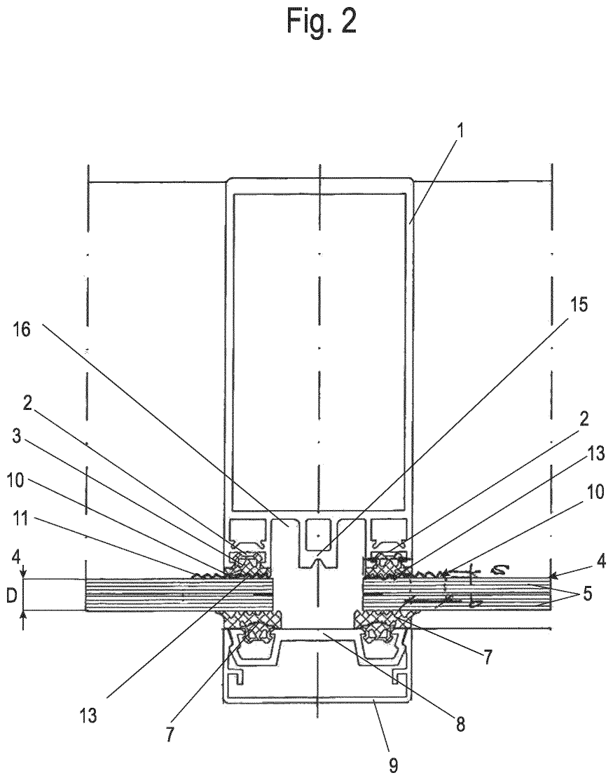

FIGS. 2 to 8 show variants for the thermal-conduction means in a window or door. Therefore, only the changes compared to the exemplary embodiment of FIG. 1 are explained below, as the other components can be designed according to the above explanations.

In FIG. 2, a metal foil, in particular an aluminum foil, is provided as a thermal-conduction means 10, which, however, is not arranged in an angular shape as in FIG. 1, but linearly. A first section 13 is arranged between the inner sealing profiled element 3 and the inside of the edge of the insulating glazing unit 4. A second section or leg 11 of the metal foil is bonded to the inside of the insulating glazing unit 4 adjacent to the inner sealing profiled element 3. This can also generate a certain heat flow that heats the region on the inner side adjacent to the inner sealing profiled element 3.

Instead of a metal foil, a thermally conductive coating can also be provided, which assumes the function of heat flow.

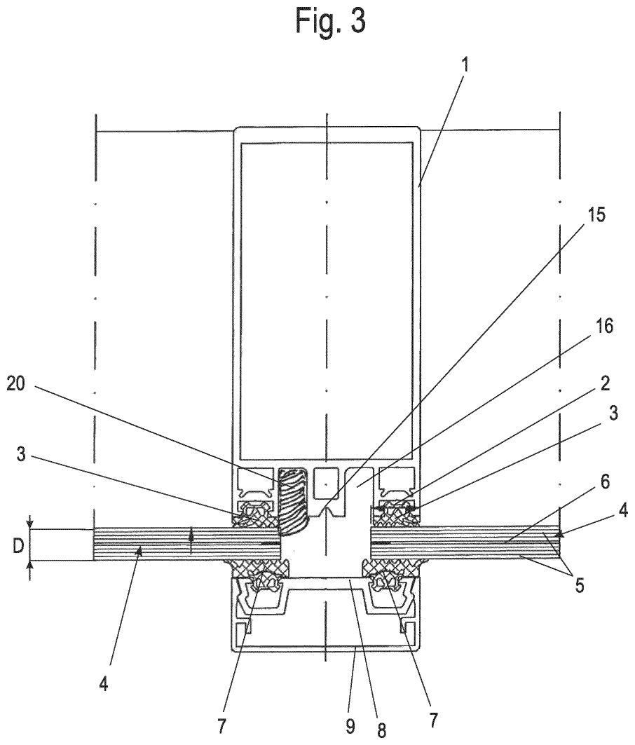

In FIG. 3, a thermal-conduction means 20 is provided, which is designed as a thermally conductive mass. The thermally conductive mass establishes a connection between the profiled element 1 and a front edge of the insulating glazing unit 4. In this way, the heat flow from the profiled element 1 on the warm inner side to the edge of the insulating glazing unit 4 can be increased in order to prevent the insulating glazing unit 4 from falling below a certain temperature on the inner side during cold outside temperatures. The heat-conducting mass can extend over the entire end face or only over a part of the end face, as shown in FIG. 3. The heat transfer can also be increased by applying a heat-conducting paste in the contact region between the insulating glazing unit 4 and the sealing profiled element 3.

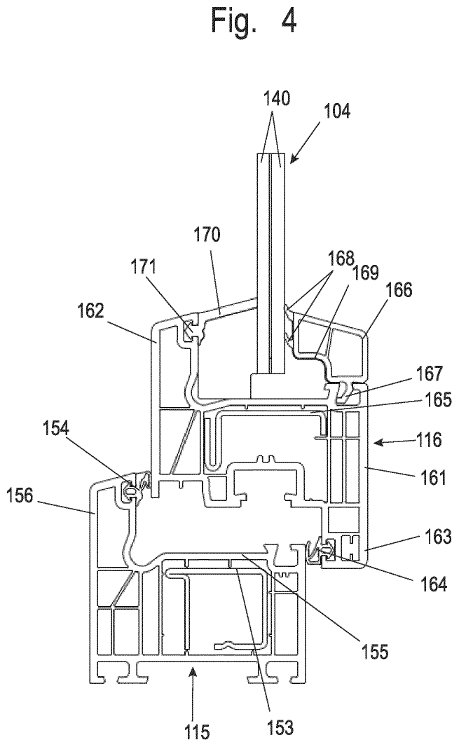

FIG. 4 shows a variant in which the thermal-conduction means 20 is provided between the profiled element 1 and the insulating glazing unit 4 on the left-hand side, wherein the thermal-conducting means opens out not at the end face of the insulating glazing unit 4 but at the outer inner face of the insulating glazing unit 4. The arrangement of the thermal-conducting means is thereby arranged in a non-visible region, so that this design is particularly visually appealing. On the right side, the thermal-conduction means 30 is integrated into the sealing profiled element 3, for example by means of a region of increased thermal conductivity which has a higher thermal conductivity than the outer region of the sealing profiled element 3, wherein a production can be carried out, for example, by coextrusion of the sealing profiled element 3 with materials having good thermal conductivity.

For example, paste-like materials can be used as thermally conductive masses, such as sealants with conductive guides, e.g., with metallic fibers, such as aluminum fibers, copper fibers, brass fibers or fibers with increased conductivity, thermally conductive paste, e.g., in the form of silicone oil with zinc oxide or aluminum, with copper, with graphite or silicone sealant with aluminum powder.

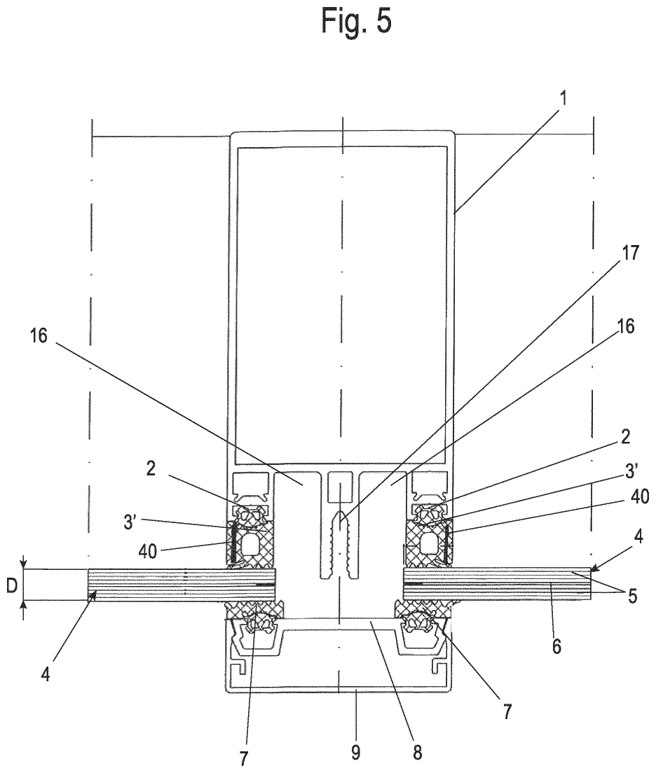

In FIG. 5, a window or door is provided with a thermal-conduction means 40 for increasing the thermal conductivity, which is arranged as an insert in the inner sealing profiled element 3′. The sealing profiled element 3′ has a somewhat greater extension in a direction perpendicular to the plane of the insulating glazing unit 4 than the inner sealing profiled element 3. The insert of the thermal-conduction means 40 is formed as a strip extending from the region adjacent to the warmer profiled element 1 to the insulating glazing unit 4 in order to increase the heat conduction in the edge region of the insulating glazing unit 4. The shape of the insert of the thermal-conduction means 40 can be freely selected in further regions, for example the insert can also be cord-shaped, i.e., with a round cross-section instead of ribbon-shaped. Thin resilient metallic sheets can be attached to or in the sealing profiled element 3 as an insert.

In the profiled element shown, a screw channel 70 is also formed between the two grooves 2, which is arranged between two drainage channels 16.

Instead of providing an insert as a thermal-conduction means 40 in the form of a tape or cord, a metal powder or metal particles can also be added to the inner sealing profiled element 3 or 3′ to increase the thermal conductivity. Normal EPDM sealing profiles have a thermal conductivity of about 0.25 W/(mK), so when metal powder is added, the thermal conductivity can be increased to more than 1 W/(mK), for example, to avoid the formation of cold spots on the inside adjacent to the sealing profiled element 3 or 3′. The sealing profiled element 3, or 3′ with increased thermal conductivity can, for example, be made of rubber grades with admixtures of metal powder or metal oxides.

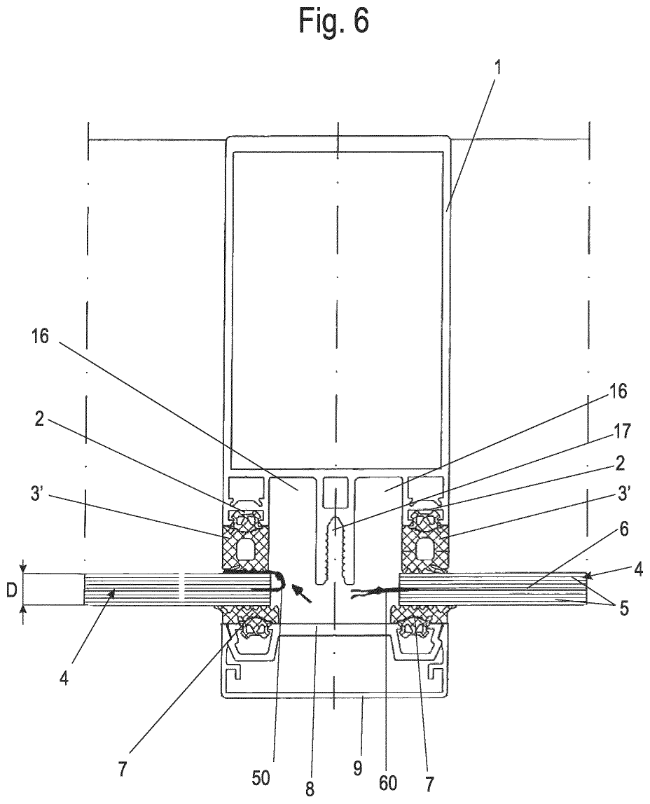

FIG. 6 shows an exemplary embodiment in which a sheet, in particular of a metal foil, is used as a thermal-conduction means 50, which engages with a section between the glass panes 5 and is connected there, for example, to the sealing means between the glass panes 5. An extension projecting from the thermal-conduction means 50 at the end face of the insulating glazing unit 4 can be bent over in such a way that it is arranged between the inner sealing profiled element 3′ and the inner face of the insulating glazing unit 4, as is shown in FIG. 6 on the left-hand side. Alternatively, as illustrated on the right-hand side of FIG. 6, the extension of a thermal-conduction means 60 may also protrude into the interior space between the pressure profiled element 8 and the profiled element 1.

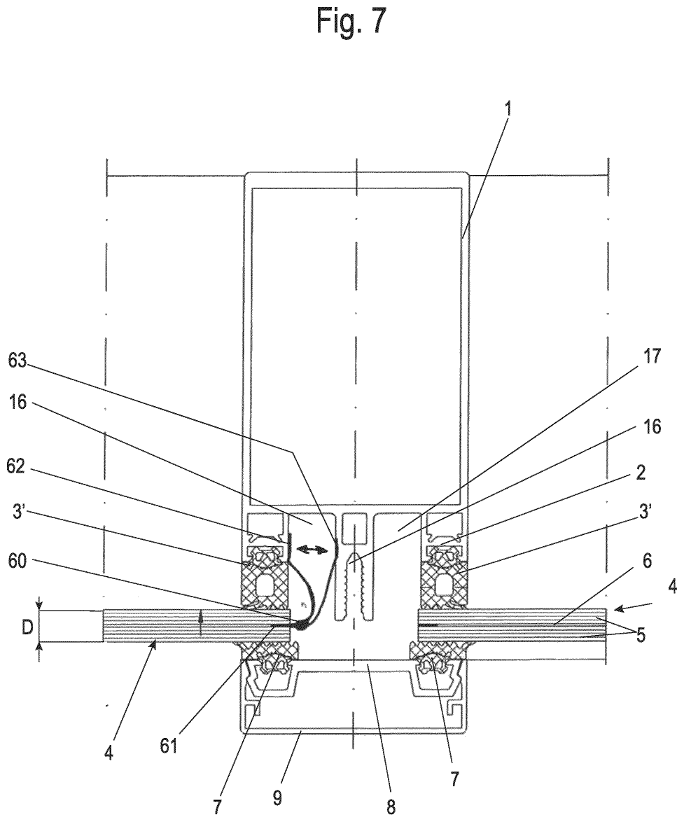

In the exemplary embodiment shown in FIG. 7, a thermal-conduction means 60 is shown that engages with a section 61 between the glass panes 5 of the insulating glazing unit 4 and is connected there, for example, with the sealing means. The extension projecting from the insulating glazing unit 4 is fixed with a first section 62 to the profiled element 1 in the region of the groove 2, while a second section 63 is connected to the screw channel 17. The connection can be made by gluing, soldering or other fastening techniques.

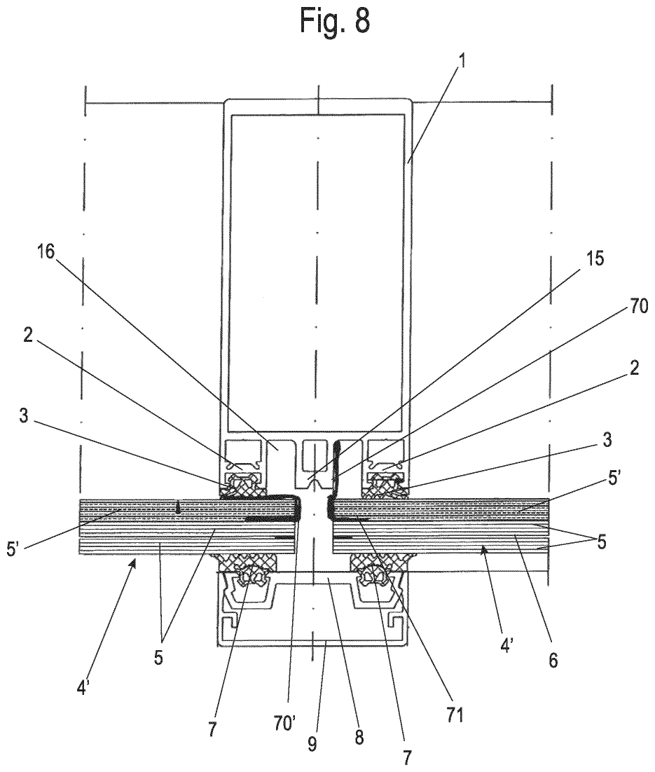

FIG. 8 shows a further exemplary embodiment of a window according to the invention in which the insulating glazing unit has not only two glass panes 5, but an additional third glass pane 5′. The glass panes 5 are again spaced from one another by an intermediate space 6, which is subjected to negative pressure. In addition, a further glass pane 5′ is provided on an inner side, e.g., a pane of polycarbonate/material with lower conductivity. As a thermal-conduction means 70, a strip in the form of a ribbon is provided, for example a metal foil, which engages with a section 71 between the glass pane 5′ and the inner of the glass panes 5. The thermal-conduction means 70 is further fixed to the fastening projection 15 on the right side, while on the left side the thermal-conduction means 70′ is provided between the inner sealing profiled element 3 and the inner side of the glass pane 5′. By means of the thermal-conduction means 70 or 70′, the edge region of the insulating glazing unit 4 can be heated in order to prevent the formation of condensation on the inside during cold outside temperatures.

The thermal-conduction means 10 to 70 can also be combined with each other as desired. For example, the inner sealing profiled elements 3 can be made more conductive by the insertion or addition of powdered metal particles, and in addition another measure can also be used to increase the thermal conduction to the edge region of the insulating glazing unit 4 or 4′. Alternatively, or additionally, the heat conduction can also be increased by reducing the thickness of the sealing profiles 3, which can, for example, be made thinner than 4 mm, preferably thinner than 3 mm. In this case, the thermal-conduction means are preferably designed in such a way that at an outside temperature of −10° C. and an inside temperature of 20° C., the isotherm of 10° C. does not touch the surface of the insulating glazing unit 4 or 4′.

At outdoor temperatures below −10° C. (standard whiter situation in Eastern Europe), the combination of several means might be required (e.g., low sealing height plus metal bond and/or metal insert).

A different combination of the above measures is reasonable and conceivable under certain geographical (temperature/humidity) circumstances.

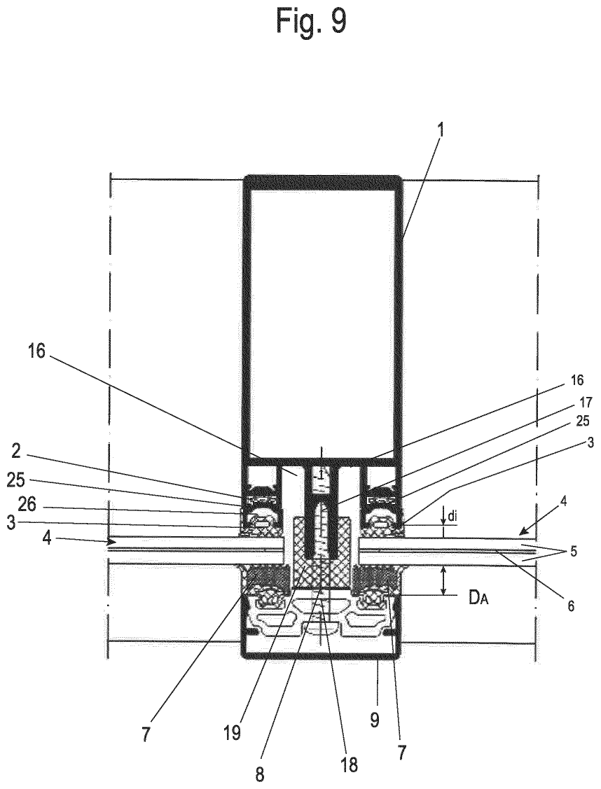

FIG. 9 shows a profiled element 1 with two grooves 2, in which comparatively thin inner sealing profiled elements 3 are mounted on an inner side of the insulating glazing unit 4 to increase thermal conductivity. The thickness dᵢ of the sealing profiled element 3 corresponds to the distance between the surface of the insulating glazing unit 4 and the end face, facing the insulating glazing unit, of a groove wall of a groove 26 for receiving a foot of the sealing profiled element 3. The outer seal 7 on the pressure profiled element 8 is thicker with a thickness D_{A}, for example with a thickness between 5 mm to 20 mm, in particular 10 mm to 15 mm.

In order to be able to mount a thin sealing profiled element 3 on the profiled element 1, an adapter profiled element 25 is held, preferably latched, on the groove 2 in each case, on which the groove 26 for accommodating the sealing profiled element 3 is formed. This allows the profiled element 1 to be used optionally for thick sealing profiles, as used for thick insulating glazing units with a thickness greater than 24 mm, or for the thin sealing profiles 3 shown for the thin insulating glazing unit 4.

The recess depth of the insulating glazing unit 4 corresponds approximately to the width of the sealing profiles 3 and is between 5 to 15 mm, preferably between 8 to 12 mm. To increase the thermal insulation in the space between the end faces of the adjacent insulating glazing units 4, an insulating block 19 is provided, which may consist of a foamed material. The insulating block 19 overlaps the screw channel 17 and extends to an inner side of the pressure profiled element 8.

The two insulating glazing units 4 are fixed at the edge to the profiled element 1 via the pressure profiled element 8, which in this exemplary embodiment is made of plastic and is held on the screw channel 17 by screws 18. Optionally, a thermal-conduction means 10 to 70 can also be provided in addition.

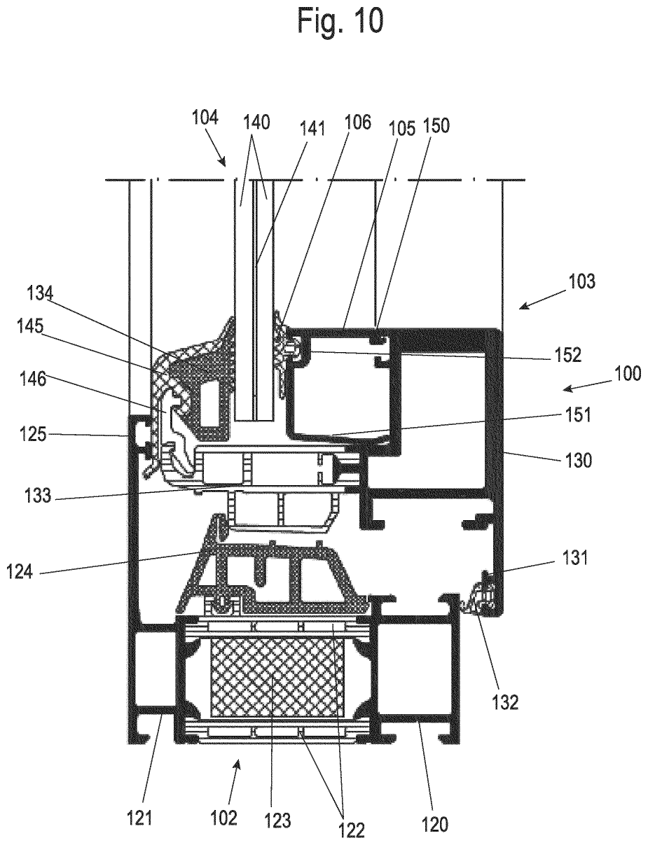

In FIG. 10, a window 100 is shown comprising a fixed frame 102 made of profiled elements and a sash frame 103 made of profiled elements.

The fixed frame 102 is formed from composite profiled elements and has a metallic inner profiled element 120 and a metallic outer profiled element 121, which are connected to one another via one or more insulating profiled elements 122, preferably made of plastic. Optionally, an insulating block 123 may also be provided in the region of the insulating profiled elements 122 to increase the thermal insulation. In the central region of the insulating profiled elements 122, a central seal 124 is provided which, in the closed position of the sash frame, cooperates with a stop of the sash frame.

The sash frame 103 is also formed from composite profiled elements and comprises a metallic inner profiled element 130, on which a web 131 projecting towards the fixed frame 102 is integrally formed with a stop seal 132. One or more insulating profiled elements 133 are fixed to the metallic inner profiled element 130, which is connected on the outside to a holder 145, which is fixed to an insulating profiled element 133 via a fastening means 146. The holder 145 and/or the fastening means 146 may be made of plastic and/or metal. Via the holder 145, an outer seal 134 is pressed in a clamping manner against an insulating glazing unit 104, which is supported on the opposite side against a seal 106.

The seal 106 is not held directly to the inner profiled element 130, but via an adapter profiled element 105 that engages a groove on the inner profiled element 130 with a web 150 and is supported on a projection of the inner profiled element 130 with a second spaced web 151. The adapter profiled element 105 forms a groove 152 in which a foot of the seal 106 is inserted.

The distance between the adapter profiled element 105, which is preferably made of metal, and a surface of the insulating glazing unit 104 is preferably between 2 mm and 5 mm, in particular 3 to 4 mm, so that the outer edge of the insulating glazing unit 4 is slightly heated by the adapter profiled element 5 at cold outside temperatures.

The insulating glazing unit 104 consists of two glass panes 140, which have a thickness of between 3 and 5 mm and between which a negative pressure is formed, preferably less than 0.3 mbar, in particular less than 0.1 mbar, and especially preferably less than 0.001 mbar. Such insulating glazing units 104, also known as vacuum insulating glazing units, have a low thickness and a high thermal insulation.

The glass insertion of the insulating glazing unit 104, i.e., the length of the edge arranged between the strip-shaped seals 106 and 134, is preferably in the range between 5 mm and 25 mm, in particular 10 mm to 15 mm.

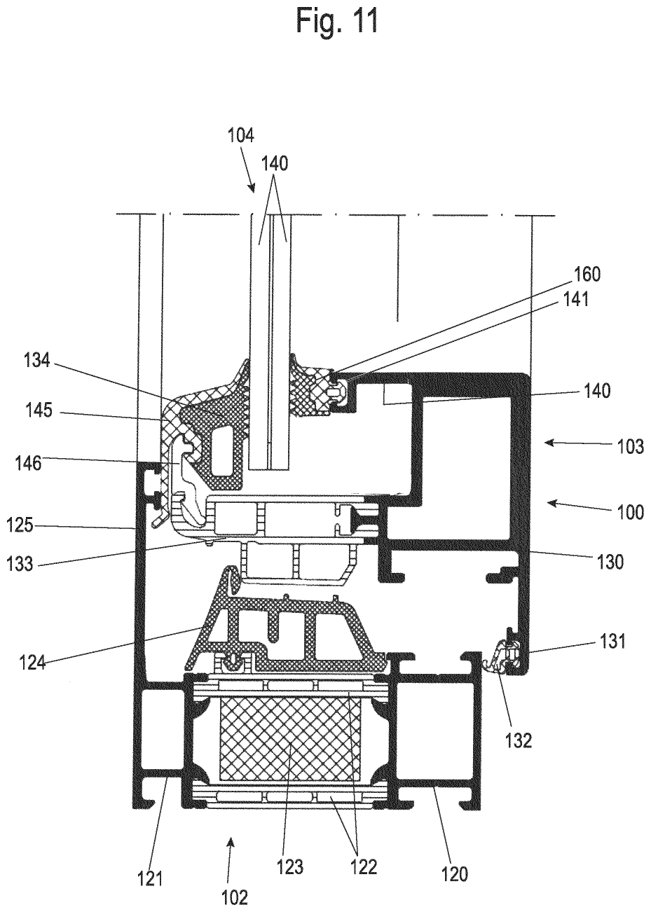

In FIG. 11, a variant of the embodiment of FIG. 10 is shown in which an inner web 140 integral with the inner profiled element 130 and having a groove 141 is provided instead of the adapter profiled element 105. The inner web 140 protrudes further outward than the other portions of the inner profiled element 130 and holds a sealing profiled element 160 that forms a heat-conducting means. For this purpose, the thermal conductivity of the sealing profiled element 160 is increased by at least 120% compared to known EPDM seals with a thermal conductivity of 0.25 W/(mK), preferably the thermal conductivity of the sealing profiled element 160 is designed to be higher then 0.8 W/(mK) at least in sections.

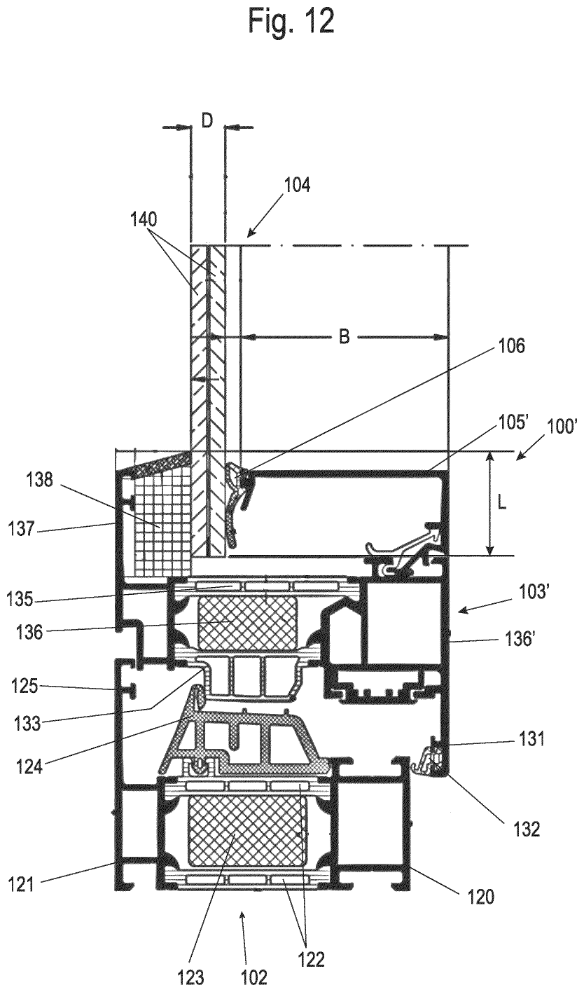

FIG. 12 shows a modified embodiment of a window 100′ in which the fixed frame 102 is formed as in the previous exemplary embodiment. Only the sash frame 103′ has been modified, wherein a metallic inner profiled element 130′ is provided which is connected to a metallic outer profiled element 137 via one or more insulating profiles 133 and 135, in the region of the insulating profiles 133 and 135, an insulating block 136 is also provided to increase the thermal insulation.

A receptacle for an insulating block 138 is formed on the metallic outer profiled element 137, preferably of a foamed material, which is pressed against an edge of the insulating glazing unit 104. The insulating block 138 is thereby surrounded on three sides by the metallic outer profiled element 137.

The metallic inner profiled element 130′ has a receptacle for fixing a glass retaining strip 105′, which is of angular design and rests with one leg against the inner profiled element 130′ and is aligned with the other leg perpendicularly to the insulating glazing unit 104. Adjacent to the insulating glazing unit 104, a seal 6 is fixed to the glass retaining strip 105′, which provides a clamping fixation of the insulating glazing unit 104 between the seal 106 and the insulating block 138.

The insulating glazing unit 104 has a thickness D of less than 13 mm, preferably less than 10 mm, for example between 7 and 9 mm. The thickness d of the sealing profiles element 106 is preferably in a range between 3 mm to 5 mm. As in the previous embodiment example, the glass insertion L is between 5 mm to 25 mm, in particular between 10 mm to 15 mm.

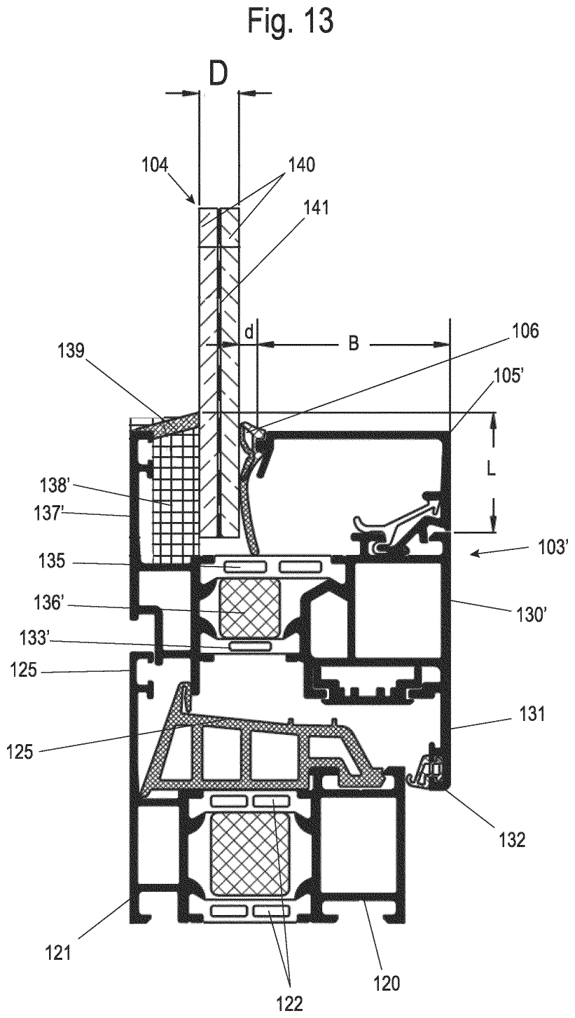

FIG. 13 shows a modified embodiment of a window compared to FIG. 12 with a fixed frame and a sash frame 103′, which have a slightly narrower width. As a result, the insulating profiled elements 122 and 135 and 133′ are somewhat shorter. The fixed frame and the sash frame are both designed as composite profiled elements having one or more insulating profiled elements between two metallic profiled elements, preferably made of aluminum.

Compared to FIG. 12, the difference in the exemplary embodiment of FIG. 13 consists in the fixation of the insulating glazing unit 104 on an outer side. The profiled element of the sash frame 103′ has a metallic outer profiled element 137′ on which, as in the previous exemplary embodiment, an insulating block 138′ is provided, for example of foamed material. However, the insulating block 138′ is surrounded by the metallic outer profiled element 137′ on only two sides, while an insulating web 139 made of a different material than the insulating block 138′ and the metallic outer profiled element 137′ is provided on the third side. The insulating web 139 connects the insulating glazing unit 104 to the metallic outer profiled element 137′ and may be formed of plastic, for example, but with higher thermal conductivity than the insulating block 138′.

The inner face width B of the glass retaining strip 105′, which extends perpendicular to the plane of the insulating glazing unit 104, may be in a range between 10 mm and 60 mm, preferably between 30 mm and 55 mm.

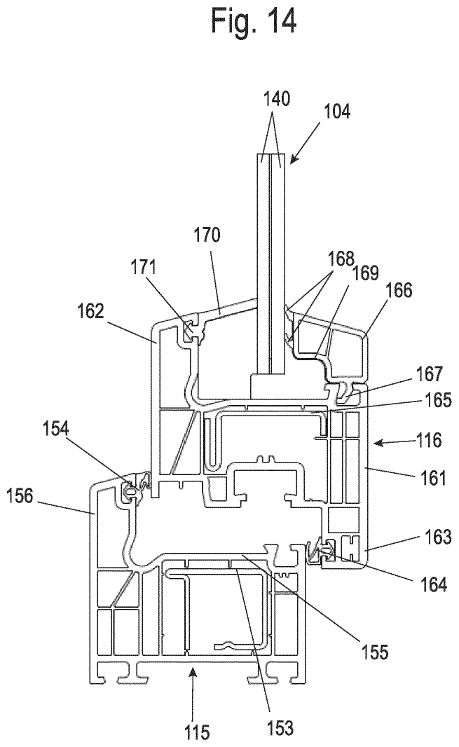

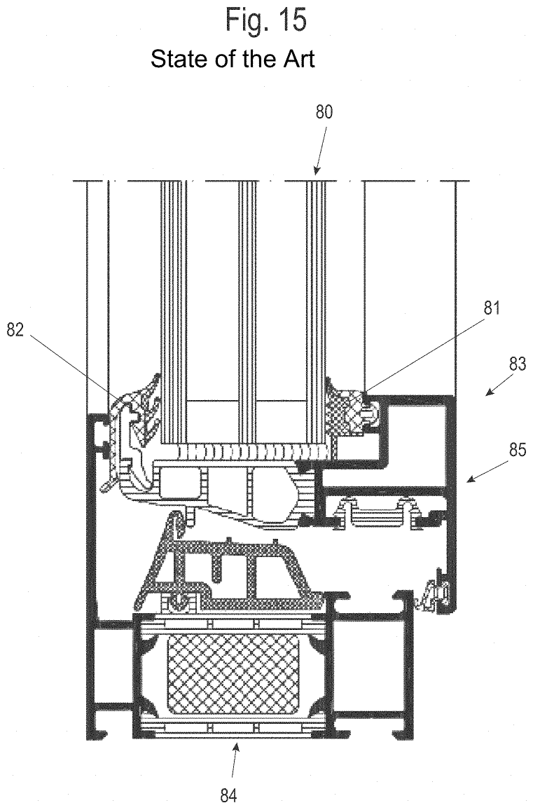

FIG. 14 shows another exemplary embodiment of a window in which a fixed frame is formed from profiled elements 115 and a sash frame is formed from profiled elements 116, both of which are essentially made from plastic, in particular by extrusion.

The profiled element 115 of the fixed frame is essentially angular with hollow chambers and comprises a leg 155 and a leg 156 arranged at an angle thereto, to which a sealing profiled element 154 is fixed. A reinforcement 153 made of metal is inserted in the leg 155 in a hollow chamber to increase stability.

The profiled elements 116 of the sash frame comprise a leg 161, which includes an outwardly projecting web 163 to which a stop seal 164 is fixed, which in the closed position abuts the fixed frame. A metal reinforcement profiled element 165 is inserted into the leg 161 in a hollow chamber. On an outer side of the profiled element 116, an inwardly projecting web 162 is provided, to which a retaining bar 170 is fixed, which engages with a foot section 171 on a groove of the web 1162. The insulating glazing unit 104 is supported externally on the web 170. Optionally, an insulating block can be held on the web 170, preferably made of a foamed material, as already shown in FIG. 2.

A glass retaining strip 166 is provided on an inner side of the insulating glazing unit 104, which engages with a foot section 167 into a groove of the profiled element 116. The glass retaining strip 166 is integrally formed with sealing strips 168, which abut the insulating glazing unit 104 in the region of an edge section. A gap is provided between an edge of the insulating glazing unit 104 and the profiled element 116 which may be filled by blocking elements.

To increase the thermal conductivity, a foil 169 made of metal is provided as a thermal-conduction means, which is provided on an inner side of the glass retaining strip 166, preferably fixed by bonding. The thermal-conduction means 169 brings heat from an inner side into the region of the edge of the insulating glazing unit 104, so that at cold outside temperatures it is ensured that the edge of the insulating glazing unit 104 is heated to a small extent in order to prevent condensation.

Instead of a metal foil, in particular an aluminum foil as a thermal-conduction means 169, a thermally conductive coating, for example of metal or plastic, can also be provided, which assumes the function of increasing the heat flow. In addition, or alternatively, the glass retaining strip 166 may also be formed wholly or partially of metal or of a plastic having good thermal conductivity, which is made of a different material than the profiled element 116.

The thermal-conduction means may also be in the form of a thermally conductive mass. The thermally conductive mass provides a connection between the profiled element 116 or the glass retaining strip 166 and a face edge of the insulating glazing unit 104. This may increase the heat flow from the profiled element on the warm inner side to the edge of the insulating glazing unit 104 to prevent the insulating glazing unit 104 from falling below a certain temperature on the inner side during cold outside temperatures. The thermally conductive mass may be arranged in a frame-like manner at the glass insertion of the insulating glazing unit 104 and may be provided instead of or in addition to the sealing strips 168.

For example, paste-like materials can be used as thermally conductive masses, such as sealants with conductive guides, e.g., with metallic fibers, such as aluminum fibers, copper fibers, brass fibers or fibers with increased conductivity, thermally conductive paste, e.g., in the form of silicone oil with zinc oxide or aluminum, with copper, with graphite or silicone sealant with aluminum powder.

To increase the thermal conductivity, a thermal-conduction means can be provided, which is arranged as an insert of the glass retaining strip 166 and/or the sealing strip 168. The shape of the insert of the thermal-conduction means can be freely selected in further regions, for example the insert can also be cord-shaped, i.e., with a round cross-section, or strip-shaped. Thin resilient metallic sheets may be provided as the insert.

A metal powder or metal particles can also be added to the sealing strip 168 and/or glass retaining strip 166 as a thermal-conduction means to increase thermal conductivity. Normal EPDM sealing profiles have a thermal conductivity of about 0.25 W/(mK), so adding metal powder can increase the thermal conductivity to more than 1 W/(mK), for example, to avoid the formation of cold spots on the inside adjacent to the sealing strip 168.

The thermal-conduction means may also be connected to one of the glass panes 140 or both glass panes 140. The thermal-conduction means may be a strip in the form of a ribbon, such as a metal foil, having a section that engages between the glass pane 140. The thermal-conduction means may heat the edge section of the insulating glazing unit 104 to prevent condensation from forming on the inside during cold outside temperatures.

The thermal-conduction means described above can also be combined with each other in any way. For example, the inner sealing profiled elements can be made more conductive by the insertion or addition of powdered metal particles, and in addition, another measure can also be used to increase the thermal conduction to the edge region of the insulating glazing unit 104.

Alternatively, or additionally, heat conduction can also be increased by reducing the thickness of the sealing profiles 6, which can be designed to be thinner than 4 mm, for example, and preferably thinner than 3 mm. The thermal-conduction means are preferably designed in such a way that at an outside temperature of −10° C. and an inside temperature of 120° C. the isotherm of 10° C. does not touch the surface of the insulating glazing unit 4.

At outdoor temperatures below −10° C. (standard winter situation in Eastern Europe), the combination of several means might be required (e.g., low sealing height plus metal bond and/or metal insert).

A different combination of the above measures is useful and conceivable under certain geographical (temperature/humidity) circumstances.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment with leaving the scope of the invention, which is defined by the claims and their legal equivalents, such as further explanations in the description.

### LIST OF REFERENCE NUMERALS

1 Profiled element made of metal
2 Groove
3, 3′ Sealing profiled element
4, 4′ Insulating glazing unit
5, 5′ Glass pane
6 Intermediate space
7 Sealing profiled element
8 Pressure profiled element
10 Thermal-conduction means
11 Leg
12 Leg
13 Section
15 Fastening projection
16 Drainage channel
17 Screw channel
18 Screw
19 Insulating block
20 Thermal-conduction means
25 Adapter profiled element
26 Groove
30 Thermal-conduction means
40 Thermal-conduction means
50 Thermal-conduction means
60 Thermal-conduction means
61 Section
62 Section
63 Section
70, 70′ Thermal-conduction means
71 Section
80 Insulating glazing unit
81, 81′ Window
82 Fixed frame
84 Insulating glazing unit
85 Adapter profiled element
105 Adapter profiled element
105′ Glass retaining strip
106 Seal
115 Profiled element
116 Profiled element
120 Inner profiled element
121 Outer profiled element
122 Insulating profiled element
123 Insulating block
124 Central seal
130, 130′ Inner profiled element
131 Web
132 Stop seal
133, 133′ Insulating profiled element
134 Seal
135 Insulating profiled element
136 Insulating block
137,137′ Outer profiled element
138, 138′ Insulating block
139 Insulating web
140 Inner web
141 Groove
145 Holder
146 Fastening means
150 Web
151 Web
152 Groove
153 Reinforcement
154 Sealing profiled element
155 Leg
156 Leg
160 Sealing profiled element
161 Leg
162 Web
163 Web
164 Stop seal
165 Reinforcement profiled element
166 Glass retaining strip
167 Foot section
168 Sealing strip
169 Thermal/conduction means
170 Retaining bar/web
171 Foot section
D, d Thickness
L Glass insertion
B Inner face width

1-17. (canceled)

18. A frame for a façade, a façade element, window or door, the frame comprising:
a plurality of profiled elements;
an insulating glazing unit held on the plurality of profiled elements, wherein the insulating glazing unit includes at least two glass panes held at a distance from one another and an intermediate space between the at least two glass panes is under negative pressure;
an inner sealing profiled element;
an outer sealing profiled element, wherein an edge of the insulating glazing unit is retained in a clamping manner between the inner sealing profiled element and the outer sealing profiled element;
pressure strips arranged on an outer side of the insulating glazing unit, wherein the pressure strips are fastened to the plurality of profiled elements of the frame;
a thermal-conduction means is provided on and/or in the inner sealing profiled elements at least in some regions so that heat is conducted to the edge of the insulating glazing unit resting against the inner sealing profiled element at cold outside temperatures and/or heat conduction is increased by a small thickness of the inner sealing profiled elements, which are thinner than 5 mm.

19. The frame of claim 18, wherein, due to the thermal-conduction means, at an outside temperature of −10° C. and an inside temperature of 20° C., a 10° C. isotherm of the façade, façade element, window, or door does not contact an inside of the insulating glazing unit.

20. The frame of claim 18, wherein a thickness of the insulating glazing unit is less than 13 mm.

21. The frame of claim 18, wherein the negative pressure in the intermediate space between the two glass panes is less than 0.3 bar.

22. The frame of claim 18, wherein the thermal-conduction means have a thermal conductivity greater than 10 W/mK.

23. The frame of claim 18, wherein the thermal-conduction means comprises a metallic material.

24. The frame of claim 18, wherein the thermal-conduction means are formed by metal inserts arranged in the inner sealing profiled element.

25. The frame of claim 24, wherein the metal inserts are in powder form and are distributed in the inner sealing profiled element.

26. The frame of claim 18 wherein the thermal-conduction means comprise a metal foil.

27. The frame of claim 26, wherein the metal foil is arranged on a surface of the inner sealing profiled element.

28. The frame of claim 18, further comprising:
a thermally conductive sealant arranged adjacent to the inner sealing profiled element between the plurality of profiled elements and the insulating glazing unit.

29. The frame of claim 18, wherein the at least two glass panes are inserted into the insulating glazing unit by a distance between 5 to 25 mm.

30. The frame of claim 18, wherein the frame is a sash frame of a window or a door and, on one of two outer sides of the insulating glazing unit, pressure strips in the form of glass retaining strips are provided, which are fixed to profiled elements of the sash frame.

31. The frame of claim 30, wherein the glass retaining strips are interchangeably clamped or latched to the sash frame.

32. The frame of claim 30, wherein the glass retaining strip is made of metal.

33. The frame of claim 30, wherein the profiled elements of the sash frame are composite profiled elements comprising a metallic outer profiled element and a metallic inner profiled element, which are connected to one another via at least one thermally insulating middle profiled element.

34. The frame of claim 30, wherein the sash frame is pivotably held in a fixed frame formed of profiled elements.
